(19) United States
(12) Patent Application Publication
(10) Pub. No.: US 2025/0045907 A1
(43) Pub. Date: Feb. 6, 2025

(54) COMPUTER IMPLEMENTED METHOD FOR DEFECT DETECTION IN AN IMAGING DATASET OF AN OBJECT COMPRISING INTEGRATED CIRCUIT PATTERNS

(71) Applicant: Carl Zeiss SMT GmbH, Oberkochen (DE)

(72) Inventors: Bjoern Froehlich, Jena (DE); Bjoern Brauer, Magstadt (DE); Alexander Freytag, Erfurt (DE); Esther Klann, Berlin (DE); Mario Kanka, Jena (DE); Bjoern Barz, Jena (DE); Xuan Truong Nguyen, Berlin (DE)

(21) Appl. No.: 18/792,755

(22) Filed: Aug. 2, 2024

(30) Foreign Application Priority Data
Aug. 4, 2023 (DE) 102023120814.4

(51) Int. Cl. G06T 7/00; G06V 10/25

(52) U.S. Cl. CPC G06T 7/0008; G06V 10/25; G06T 2207/30148

(57) ABSTRACT

The invention relates to a computer implemented method for defect detection in an imaging dataset of an object comprising integrated circuit patterns, the method comprising: obtaining defect candidates in the imaging dataset; subsequently carrying out at least two stages, each stage comprising the following steps: applying a stage specific defect detection method to the defect candidates; discarding defect-free defect candidates; obtaining detected defects in the imaging dataset from the remaining defect candidates. The invention also relates to a corresponding computer-readable medium, computer program and system.

### CROSS-REFERENCE TO RELATED APPLICATION

This application claims benefit under 35 U.S.C. § 119 (a) of German patent application 10 2023 120 814.4, filed on Aug. 4, 2023, which is hereby incorporated herein by reference in its entirety.

### TECHNICAL FIELD

The invention relates to systems and methods for quality assurance of objects comprising integrated circuit patterns, more specifically to a computer implemented method, a computer-readable medium, a computer program product and a corresponding system for defect detection in an imaging dataset of such an object. Using a cascade of defect detection methods with increasing precision, defects can be detected reliably and quickly. The method, computer-readable medium, computer program product and system can be utilized for quantitative metrology, process monitoring, defect detection and defect review in objects comprising integrated circuit patterns, e.g., in photolithography masks, reticles or wafers.

### BACKGROUND

Semiconductor manufacturing involves precise manipulation, e.g., etching, of materials such as silicon or oxide at very fine scales in the range of nm. Therefore, a quality management process comprising quality assurance and quality control is important for ensuring high quality standards of the manufactured wafers. Quality assurance refers to a set of activities for ensuring high-quality products by preventing any defects that may occur in the development process. Quality control refers to a system of inspecting the final quality of the product. Quality control is part of the quality assurance process.

A wafer made of a thin slice of silicon serves as the substrate for microelectronic devices containing semiconductor structures built in and upon the wafer. The semiconductor structures are constructed layer by layer using repeated processing steps that involve repeated chemical, mechanical, thermal and optical processes. Dimensions, shapes and placements of the semiconductor structures and patterns are subject to several influences. One of the most crucial steps is the photolithography process.

Photolithography is a process used to produce patterns on the substrate. The patterns to be printed on the surface of the substrate are generated by computer-aided-design (CAD). From the design, for each layer a photolithography mask is generated, which contains a magnified image of the computer-generated pattern to be etched into the substrate. The photolithography mask can be further adapted, e.g., by use of optical proximity correction techniques. During the printing process an illuminated image projected from the photolithography mask is focused onto a photoresist thin film formed on the substrate. A semiconductor chip powering mobile phones or tablets comprises, for example, approximately between 80 and 120 patterned layers.

Due to the growing integration density in the semiconductor industry, photolithography masks have to image increasingly smaller structures onto wafers. The aspect ratio and the number of layers of integrated circuits constantly increases and the structures are growing into 3^{rd} (vertical) dimension. The current height of the memory stacks is exceeding a dozen of microns. In contrast, the feature size is becoming smaller. The minimum feature size or critical dimension is below 10 nm, for example 7 nm or 5 nm, and is approaching feature sizes below 3 nm in near future. While the complexity and dimensions of the semiconductor structures are growing into the 3^{rd} dimension, the lateral dimensions of integrated semiconductor structures are becoming smaller. Producing the small structure dimensions imaged onto the wafer requires photolithographic masks or templates for nanoimprint photolithography with ever smaller structures or pattern elements. The production process of photolithographic masks and templates for nanoimprint photolithography is, therefore, becoming increasingly more complex and, as a result, more time-consuming and ultimately also more expensive. With the advent of EUV photolithography scanners, the nature of masks changed from transmission based to reflection-based patterning.

On account of the tiny structure sizes of the pattern elements of photolithographic masks or templates, it is not possible to exclude errors during mask or template production. The resulting defects can, for example, arise from degeneration of photolithography masks or particle contamination. Of the various defects occurring during semiconductor structure manufacturing, photolithography related defects make up nearly half of the number of defects. Hence, in semiconductor process control, photolithography mask inspection, review, and metrology play a crucial role to monitor systematic defects. Defects detected during quality assurance processes can be used for root cause analysis, for example, to modify or repair the photolithography mask. The defects can also serve as feedback to improve the process parameters of the manufacturing process, e.g., exposure time, focus, illumination, etc.

Each defect in the photolithography mask can lead to unwanted behavior of the produced wafer, or a wafer can be significantly damaged. Therefore, each defect must be found and repaired if possible and necessary. Reliable and fast defect detection methods are, therefore, important for photolithography masks.

Apart from defect detection in photolithography masks, defect detection in wafers is also crucial for quality management. During the manufacturing of wafers many defects apart from photolithography mask defects can occur, e.g., during etching or deposition. For example, bridge defects can indicate insufficient etching, line breaks can indicate excessive etching, consistently occurring defects can indicate a defective mask and missing structures hint at non-ideal material deposition etc. Therefore, a quality assurance process and a quality control process are important for ensuring high quality standards of the manufactured wafers.

Apart from quality assurance and quality control, defect detection in wafers is also important during process window qualification (PWQ). This process serves for defining windows for a number of process parameters mainly related to different focus and exposure conditions in order to prevent systematic defects. In each iteration a test wafer is manufactured based on a number of selected process parameters, e.g., exposure time, focus, etc., with different dies of the wafer being exposed to different manufacturing conditions. Exposure time refers to a duration of time the wafer is exposed to light. Focus refers to the position of the plane of best focus of the optical system relative to some reference plane, such as the top surface of the resist, measured along the optical axis. Exposure and focus determine the resist profiles. Resist profiles are often described by three parameters related to a trapezoidal approximation of the profile: the linewidth or critical dimension (CD), the sidewall angle, and the final resist thickness. Since the effect of focus depends on exposure, the only way to judge the response of the process is to simultaneously vary both focus and exposure. The focus-exposure matrix obtained this way can easily be visualized. By detecting and analyzing the defects in the different dies based on a quality assurance process, the best manufacturing process parameters can be selected, and a window or range can be established for each process parameter from which the respective process parameter can be selected. In addition, a highly accurate quality control process and device for the metrology of semiconductor structures in wafers is required. The recognized defects can, thus, be used for monitoring the quality of wafers during production or for process window establishment. Reliable and fast defect detection methods are, therefore, important for objects comprising integrated circuit patterns.

In order to analyze large amounts of data requiring large amounts of measurements to be taken, machine learning methods can be used. Machine learning is a field of artificial intelligence. Machine learning methods generally build a parametric machine learning model based on training data consisting of a large number of samples. After training, the method is able to generalize the knowledge gained from the training data to new previously unencountered samples, thereby making predictions for new data. There are many machine learning methods, e.g., linear regression, k-means, support vector machines, decision trees, random forests, neural networks or deep learning approaches.

Deep learning is a class of machine learning that uses artificial neural networks with numerous hidden layers between the input layer and the output layer. Due to this complex internal structure the networks are able to progressively extract higher-level features from the raw input data. Each level learns to transform its input data into a slightly more abstract and composite representation, thus deriving low and high level knowledge from the training data. The hidden layers can have differing sizes and tasks such as convolutional or pooling layers.

In imaging datasets of objects comprising integrated circuit patterns, usually few defects exist. However, these defects can lead to the malfunctioning of a complete device. Therefore, it is important to detect defects with a high recall, that is to detect close to 100% of the defects. Furthermore, to examine objects of integrated circuit patterns huge amounts of data have to be checked for defects, which is very time-consuming.

In US 2010/0076699 A1 a defect detection method for wafers is disclosed. The method comprises implementing two different defect detection paths comprising different filters, the first path targeted at random defects, the second path targeted at repeater defects. Both defect detection paths are applied to an imaging dataset of the wafer, and the detected defects are combined in the end. In this way, defects can be detected with a higher recall, since the filter paths can be specifically adapted to different types of defects. However, applying multiple defect detection paths in parallel is particularly time-consuming—in particular, if most of the imaging dataset is defect-free.

Therefore, it is a feature of the invention to provide a defect detection method for objects comprising integrated circuit patterns with a high recall. It is another feature of the invention to provide a defect detection method for objects comprising integrated circuit patterns with a high precision. It is another feature of the invention to provide a defect detection method for objects comprising integrated circuit patterns with a reduced computation time. It is another feature of the invention to increase the throughput of the defect detection method during quality control or quality assessment processes. It is another feature of the invention to provide a defect detection method for objects comprising integrated circuit patterns, which is easily adaptable to different applications or imaging datasets and which requires low user effort.

The features are achieved by the invention specified in the independent claims. Advantageous embodiments and further developments of the invention are specified in the dependent claims.

### SUMMARY

Embodiments of the invention concern computer implemented methods, computer-readable media and systems for defect detection in imaging datasets of objects comprising integrated circuit patterns.

A first embodiment involves a computer implemented method for defect detection in an imaging dataset of an object comprising integrated circuit patterns, the method comprising: obtaining defect candidates in the imaging dataset; subsequently carrying out at least two stages, each stage comprising the following steps: applying a stage specific defect detection method to the defect candidates; discarding defect-free defect candidates, e.g., discarding all defect-free defect candidates. Finally, the detected defects in the imaging dataset are obtained from the remaining defect candidates after the final stage.

The method comprises generating a cascade of stage specific defect detection methods. A stage specific defect detection method maps a defect candidate to a decision “no defect/possibly defect”. Optionally, a stage specific defect detection method comprises partitioning one or more defect candidates into two or more smaller defect candidates. A stage specific defect detection method can, for example, use complete images, patches, bounding boxes or pixels as defect candidates. Defect candidates that contain no defect are discarded, whereas defect candidates that possibly contain a defect are investigated further. Each stage specific defect detection method is applied to the remaining defect candidates after the previous stage. By iteratively discarding defect candidates, large amounts of the imaging dataset that are defect-free can already be discarded in a very early stage. Thus, the set of defect candidates is reduced with each stage. At the same time, defects that are difficult to detect are examined using various defect detection methods. In this way, a high recall and precision and a low computation time can be achieved.

An integrated circuit pattern can, for example, comprise semiconductor structures. An object comprising integrated circuit patterns can refer, for example, to a photolithography mask, a reticle or a wafer. In a photolithography mask or reticle the integrated circuit patterns can refer to mask structures used to generate semiconductor patterns in a wafer during the photolithography process. In a wafer the integrated circuit patterns can refer to semiconductor structures, which are imprinted on the wafer during the photolithography process.

The object comprising integrated circuit patterns may be a photolithography mask. The photolithography mask may have an aspect ratio of between 1:1 and 1:4, preferably between 1:1 and 1:2, most preferably of 1:1 or 1:2. The photolithography mask may have a nearly rectangular shape. The photolithography mask may be preferably 5 to 7 inches long and wide, most preferably 6 inches long and wide. Alternatively, the photolithography mask may be 5 to 7 inches long and 10 to 14 inches wide, preferably 6 inches long and 12 inches wide.

A defect detection method is a method that can be used to discard defect candidates by discriminating between defective and defect-free defect candidates. Defect detection methods, thus, on the one hand comprise methods that detect defective defect candidates, e.g., by analyzing properties of the imaging dataset or subsets thereof for defects. The undetected defect candidates can then be discarded as defect-free defect candidates. Defect detection methods, on the other hand, also comprise methods that directly detect defect-free defect candidates, e.g., by analyzing the unobtrusiveness of the imaging dataset or subsets thereof, which can then be discarded. The remaining defect candidates are then examined further in subsequent stages of the method.

A stage specific defect detection method is a defect detection method used in or provided for or designed for a specific stage of the method. In an example, in different stages different stage specific defect detection methods are used. Thus, each stage specific defect detection method is different from all other stage specific defect detection methods. Alternatively, the same defect detection method can be used in two or more stages. Furthermore, stages of the method can be repeated.

The term “defect” refers to a localized deviation of an integrated circuit pattern from an a priori defined norm of the integrated circuit pattern. The norm of the integrated circuit pattern can be defined by a corresponding reference object or dataset, e.g., a model dataset (e.g., using a CAD design) or an acquired defect-free dataset or a simulated dataset. For instance, a defect of an integrated circuit pattern, e.g., of a semiconductor structure, can result in malfunctioning of an associated semiconductor device. Depending on the detected defect, for example, the photolithography process can be improved, or photolithography masks or wafers can be repaired or discarded.

The term “defect candidate” refers to a subset of the imaging dataset that may comprise a defect. The subset can, for example, be an image, a 2D or 3D local region of any shape and size, a bounding box of any shape and size, etc. The defect candidate can comprise a complete defect, a part of a defect, or it can be defect-free. A defect candidate can, for example, be indicated by a set of coordinates referring to some coordinate system of the imaging dataset. Alternatively, it can be indicated by a contour in the imaging dataset. The properties of defect candidates depend on the stage specific defect detection method and, thus, can vary in each stage.

The imaging dataset can comprise one or more images of one or more portions of the object comprising integrated circuit patterns or of the whole object. According to the techniques described herein, various imaging modalities may be used to acquire the imaging dataset. Imaging datasets can comprise single-channel images or multi-channel images, e.g., focus stacks. For instance, it is possible that the imaging dataset includes 2-D images. It is possible to employ a multi beam scanning electron microscope (mSEM). mSEM employs multiple beams to acquire contemporaneously images in multiple fields of view. For instance, a number of not less than 50 beams could be used or even not less than 90 beams. Each beam covers a separate portion of a surface of the object comprising integrated circuit patterns. Thereby, a large imaging dataset is acquired within a short duration of time. Typically, contemporary machines acquire 4.5 gigapixels per second. For illustration, one square centimeter of a wafer can be imaged with 2 nm pixel size leading to 25 terapixels of data. Other examples for imaging datasets including 2D images relate to imaging modalities such as optical imaging, phase-contrast imaging, x-ray imaging, etc. It is also possible that the imaging dataset is a volumetric 3-D dataset, which can be processed slice-by-slice or as a three-dimensional volume. Here, a crossbeam imaging system including a focused-ion beam (FIB) source, an atomic force microscope (AFM) or a scanning electron microscope (SEM) could be used. For example, the imaging system can include one or more arrays of individually addressable sensing elements or pixels. For example, the imaging system can include a charge-coupled device (CCD) sensor array, or a complementary metal-oxide-semiconductor (CMOS) sensor array. Furthermore, magnetic resonance (MR) images, ultrasound images or computed tomography (CT) images could be used. Multimodal imaging datasets may be used, e.g., a combination of x-ray imaging and SEM. The imaging dataset can, additionally or alternatively, comprise aerial images acquired by an aerial imaging system. An aerial image is the radiation intensity distribution at substrate level. It can be used to simulate the radiation intensity distribution generated by a photolithography mask during the photolithography process. The aerial image measurement system can, for example, be equipped with a staring array sensor or a line-scanning sensor or a time-delayed integration (TDI) sensor.

In an example, at least three stages are carried out by the method. By using at least three different stage specific defect detection methods defect candidates can be successfully examined, thereby improving the recall and precision of the method for defect detection. According to an aspect of the invention, three stages are carried out by the method. Alternatively, at least four or at least five stages can be carried out by the method. With each additional stage the recall and precision of the method can be improved. However, using less stages can require less computation time.

According to an example, for a substantial number of stages, the spatial extent of the defect candidates examined by the stage specific defect detection method is smaller than the spatial extent of defect candidates examined by the stage specific defect detection method in a preceding stage. For example, in a first stage, the defect candidates are images (e.g., slices of a 3D imaging dataset) or sub-volumes, in a second subsequent stage the defect candidates are bounding boxes within the images or sub-volumes, and in a third subsequent stage the defect candidates are subsets of the bounding boxes. The term bounding box refers to a connected region of any size and shape within an image or sub-volume, respectively. In this way, large defect-free regions, e.g., images or bounding boxes, can be discarded in an early stage, thereby reducing the computation time of the method. Throughout this document, a substantial number of elements (e.g., stages or stage specific defect detection methods) refers to at least 50% of the elements, preferably at least 75% of the elements, more preferably at least 90% of the elements, most preferably at least 95% of the elements. In a preferred example, a substantial number of elements refers to all elements, e.g., all stages in the defect detection method or all stage specific defect detection methods in the defect detection method.

According to an example, for a substantial number of stages, the computation time of the stage specific defect detection method on all defect candidates in that stage is lower than the computation time of the stage specific defect detection method on the defect-free defect candidates of the subsequent stage. In this way, the computation time of the method is reduced compared to applying only the stage specific defect detection method of the subsequent stage to all defect candidates.

According to an aspect of the invention, the false negative rate of the stage specific detection methods is below 5%, preferably below 2%, more preferably below 1%, most preferably below 0.5% or even below 0.1%. This ensures that only very few defects are missed in a stage, since missed defects cannot be retrieved by a subsequent stage. Thus, a high recall of the method is obtained.

According to an aspect of the invention, for a substantial number of stages, the precision of the stage specific defect detection method is higher than the precision of the stage specific defect detection method in a preceding stage. In this way, the precision increases with the number of stages, thereby ensuring a high precision of the whole defect detection method. In an example, the recall decreases with the stage number, whereas the precision increases with the stage number.

In an example, at least two of the stage specific defect detection methods only differ in their control parameters. Thus, the same stage specific defect detection method is used in at least two stages, but with differing control parameters. In an example, at least a substantial number of the stage specific defect detection methods only differ in their control parameters. According to an aspect of the invention, all stage specific defect detection methods only differ in their control parameters. In this way, the recall and precision can be easily controlled by simply modifying the parameters of the stage specific defect detection methods. Thus, the method is simple to apply and versatile to obtain target recall and precision values. In the context of this invention, a control parameter refers to an input to a stage specific defect detection method that is assigned a value from a set of predefined possible values, for example a numeric value or a value from a set comprising a specific number of selections, and which influences the outcome of the stage specific detection method when applied to data. For example, control parameters are threshold values, filter sizes, or architectural parameters defining the architecture of a machine learning model such as the number or sizes of layers, the number of neurons, the number or sizes of filters, the batch size, the number or size of codebook entries, the number or dimension of a subspace, etc. A learning rate, in contrast, is not regarded as a control parameter, since it has no influence on the outcome of the stage specific defect detection method when applied to data.

The method according to the invention is particularly useful for imaging datasets comprising only few defects, since in this case large parts of the defect candidates can be easily discarded and only few defect candidates have to be examined further. Thus, computation time is saved. Therefore, in an example, less than 10% of the imaging dataset, preferably less than 5% of the imaging dataset, more preferably less than 3% of the imaging dataset, most preferably less than 1% of the imaging dataset comprises a defect.

It is advantageous, if intermediate results obtained by a stage specific defect detection method are re-used by a stage specific defect detection method in a subsequent stage. For example, features that are computed in a first stage can be re-used in a subsequent stage. These features can be computed using feature extraction methods such as edge detectors, object detectors, Hough transforms, filters such as Garbor filters, SIFT feature extractors, Fourier feature extractors, pattern matching, neural networks, etc. The features can, for example, comprise edges, locations of objects or patterns such as circles or lines, vectors containing filter responses or Fourier coefficients, SIFT features, activations of neurons in a layer of a neural network, etc. In this way, the computation time of the method is reduced.

According to an example, one or more stage specific defect detection methods estimate properties of the defect candidates, and the properties are used to discard defect-free defect candidates. Properties can refer, for example, to the size, material or location of a defect candidate. These properties can be estimated using, e.g., image processing or machine learning methods. The size of a defect candidate can, for example, be estimated by fitting a basic shape such as a circle or line to the defect candidate and deriving its size from the size of the basic shape, or by applying pattern matching methods, e.g., to detect center and radius of circles, etc. Machine learning models can be trained to map defect candidates in an image to material, size or other properties. Based on these properties a simple and quick decision to discard defect candidates can often be taken. For example, defect candidates with a size below a minimum defect size can be discarded. Or defect candidates within a region of no interest can be discarded. Or defect candidates within a material of no interest can be discarded. Such fast filtering steps can be included in one or more stages of the method. In this way the precision of the method is increased and the computation time is reduced.

According to a preferred embodiment of the invention, at least one, preferably a substantial number of, stage specific defect detection method comprises a machine learning method, the machine learning method comprising a trained machine learning model. Machine learning methods are trained using training data, i.e., examples, and thus, independently derive their knowledge from the training data instead of requiring a user to define rules for defect detection. In this way, optimal defect detection results can be obtained automatically in a data-driven way. Thus, the use of machine learning methods increases the recall and precision of the stage specific defect detection methods and reduces the user effort.

According to an example, a substantial number of stage specific defect detection methods comprises a machine learning method, and, for these stages, the complexity of the machine learning model of the machine learning method is higher than the complexity of the machine learning model of the machine learning method of a preceding stage. In this way, the computation time can be reduced and the recall and precision improved. The complexity of a machine learning model refers to measurable properties of the machine learning model concerning computation time or structure of the machine learning model. For example, the computation time or the required number of floating point operations for a forward pass can be used as a measure of complexity. Alternatively, structural properties of the machine learning model can be used to measure the complexity, e.g., the number, size or dimension of layers, neurons, feature vectors, filters, codebook entries, decision boundaries, subspaces, subtrees etc.

According to an aspect of the invention, for at least one stage, the stage specific defect detection method is selected from a set of stage specific defect detection methods. Thus, for these stages, a set or pool of stage specific defect detection methods is specified, e.g., by a user, and from the set a stage specific defect detection method is selected, e.g., by a user or automatically. In this way, the method can be easily adapted to different applications or imaging datasets or to different target recall and precision requirements. In an example, the methods within a set of stage specific defect detection methods only differ by their control parameters, as described above.

In an example, for at least one stage, the stage specific defect detection method is automatically selected from the set of stage specific defect detection methods according to some criterion. The criterion can, for example, comprise the contents of the imaging dataset such as the type of integrated circuit patterns in the object. The criterion can, for example, also comprise the computation time of the stage specific defect detection method, or a maximum computation time for a single stage or all stages together. The criterion can, for example, comprise a predefined minimum recall or a predefined minimum precision for one or more stages. The criterion can, for example, comprise the confidence level of the stage specific defect detection method, e.g., using the softmax in case of a machine learning method. The criterion can also comprise a known true positive rate or a known false positive rate for comparable input data. The criterion can, for example, comprise the efficiency of the stage specific defect detection method. The efficiency can, for example, be measured using the computation time per pixel and the reduction rate indicating the percentage of the defect candidates that remains after applying the stage specific defect detection method. Different criteria can be optimized jointly, for example, by optimizing an objective function. The stage specific defect detection method can be automatically selected at each stage. Alternatively, a sequence of stage-specific defect detection methods can be automatically designed before the first stage. By automatically selecting a stage specific defect detection method from a set of stage specific defect detection methods, the user effort is minimized. In addition, recall and/or precision can be optimized, or the computation time can be minimized, or the computation time can be controlled to fulfill specific requirements.

According to an aspect of the invention, for at least one stage, the stage specific defect detection method is selected from the set of stage specific defect detection methods using meta-data concerning the imaging dataset. In this way, the stages can be specifically adapted to the imaging dataset or application at hand. Meta-data concerning the imaging dataset comprises the contents of the imaging dataset, e.g., the type of integrated semiconductor structures in the imaging dataset (e.g. lines and spaces, pillars, etc.), the critical dimension, the location of the imaged area within the object comprising integrated circuit patterns, the size or location of relevant defects, the image quality, image acquisition settings, the modality of the imaging dataset (e.g., SEM, FIB-SEM, Xray, CT, MRT, etc.), properties of integrated circuit patterns such as distances, shapes, locations, regularity, patterns, etc. For example, a set of stage specific defect detection methods can contain a set of machine learning models each of which is trained for a specific meta-data or meta-data combination, e.g., one machine learning model can be trained for lines and spaces in SEM images, another one for pillars in FIB-SEM images, another one can be trained for critical dimensions above X, another one can be trained for the boundary of wafers, another one can be trained for a minimum defect size of X pixels, etc. These specific machine learning models can be obtained using training data corresponding to the selected meta-data or meta-data combination, e.g., a SEM imaging dataset showing lines and spaces and defect identifiers, etc. Meta-data properties can be obtained from an imaging dataset by image processing or machine learning, they can be derived from machine parameters, or they can be indicated by a user or obtained from a database. Depending on the meta-data properties of an imaging dataset the corresponding trained machine learning model can be automatically selected, e.g., from a database of machine learning models. Alternatively, a user can select the machine learning models to use on an imaging dataset.

In an example, one or more stage specific defect detection methods use a reference dataset to discard defect-free defect candidates. The reference dataset is an imaging dataset. The reference dataset can be used to detect defects in defect candidates such that all remaining defect candidates can then be discarded afterwards. In this case, the reference dataset can comprise a predominantly defect-free dataset. Predominantly defect-free means that less than 10% of the dataset, preferably less than 5% of the dataset, more preferably less than 1% of the dataset, most preferably less than 0.1% of the dataset comprises a defect. For example, the reference dataset can be used to directly discard defect-free defect candidates, e.g., by comparing defect candidates to the reference dataset or to a portion thereof. Alternatively, information can be derived from the reference dataset, e.g., typical properties of non-defects such as locations, sizes, appearances, etc. Statistics over such properties can be derived from the reference dataset, since this is assumed to be defect-free or nearly defect-free. Statistics can, for example, be derived from a range of structure sizes computed in the reference dataset, e.g., from a range of circle radii computed in a pillars reference dataset or from a range of line thicknesses computed in a lines and spaces reference dataset. These statistics can be used by defect detection methods to derive a defect likelihood for a defect candidate. For example, circle radii that are highly unlikely probably indicate a defect. The reference dataset can be obtained in different ways. It can comprise an acquired imaging dataset or an artificially generated imaging dataset. In an example, the reference dataset is obtained by acquiring images of a reference object comprising integrated circuit patterns. The reference object comprising integrated circuit patterns can, for example, be another instance of the same type of object, or it can be of a different type but comprising at least a portion of the same integrated circuit patterns as the object. In another example, the reference dataset is obtained from one or more portions of the (same) object comprising integrated circuit patterns, e.g., from another die of the object, for example in case of repetitive structures. In another example, the reference dataset is artificially generated. For example, the reference dataset is obtained from simulated images of the object comprising integrated circuit patterns, e.g., from CAD files or simulated aerial images. The appearance of the simulated reference dataset can be similar to the appearance of the imaging dataset, e.g., by using a machine learning model such as a generative adversarial neural network (GAN) that is trained to imitate the appearance of images. The simulated images can, for example, be loaded from a database or a memory or a cloud storage. Alternatively, the reference dataset can comprise information about defects, e.g., typical properties of defects such as locations, sizes, appearance, etc. Using this kind of information, defects can be detected more easily, e.g., by use of pattern matching techniques or by using the reference dataset as training data for a machine learning model.

According to an embodiment of the invention, the computer implemented method for defect detection comprises a machine learning model, and the stage specific defect detection method in a substantial number of stages comprises at least one intermediate layer followed by a classifier that classifies intermediate results as defect or non-defect in the machine learning model. Thus, the stages of the defect detection method together form a single machine learning model, wherein a substantial number of stages comprises at least one intermediate layer and a classifier for discarding defect-free defect candidates. The number of intermediate layers can differ in different stages. By discarding defect-free defect candidates as early as possible, the computation time of the method is reduced.

A computer-readable medium, according to an embodiment of the invention, has a computer program executable by a computing device stored thereon, the computer program comprising code for executing a method of any of the embodiments, examples or aspects or combinations thereof described above.

A computer program product, according to an embodiment of the invention, comprises instructions which, when the program is executed by a computer, cause the computer to carry out a method of any of the embodiments, examples or aspects or combinations thereof described above.

A system for defect detection in an object comprising integrated circuit patterns according to an embodiment of the invention comprises: an imaging device configured to provide an imaging dataset of the object comprising integrated circuit patterns; one or more processing devices; and one or more machine-readable hardware storage devices comprising instructions that are executable by one or more processing devices to perform operations comprising a method of any of the embodiments, examples or aspects or combinations thereof described above.

The invention described by examples and embodiments is not limited to the embodiments and examples but can be implemented by those skilled in the art by various combinations or modifications thereof.

### BRIEF DESCRIPTION OF DRAWINGS

FIG. 1 illustrates an exemplary transmission-based photolithography system, e.g., a deep ultraviolet (DUV) photolithography system;

FIG. 2 illustrates an exemplary reflection-based photolithography system, e.g., an extreme ultraviolet (EUV) photolithography system;

FIG. 3 shows an imaging dataset of an object comprising integrated circuit patterns in the form of a photolithography mask comprising a defect;

FIG. 4 illustrates a flowchart of a computer implemented method for defect detection in an imaging dataset of an object comprising integrated circuit patterns according to an embodiment of the invention;

FIG. 5 illustrates the process of iteratively discarding defects in a defect detection cascade;

FIG. 6 illustrates efficiencies for different defect detection methods;

FIG. 7 illustrates a computer implemented method for defect detection comprising a machine learning model, wherein the stage specific defect detection method in a substantial number of stages comprises at least one intermediate layer followed by a classifier that classifies intermediate results as defect or non-defect; and

FIG. 8 illustrates a system for defect detection in an object comprising integrated circuit patterns according to an embodiment of the invention.

### DETAILED DESCRIPTION

In the following, advantageous exemplary embodiments of the invention are described and schematically shown in the figures. Throughout the figures and the description, same reference numbers are used to describe same features or components. Dashed lines indicate optional features.

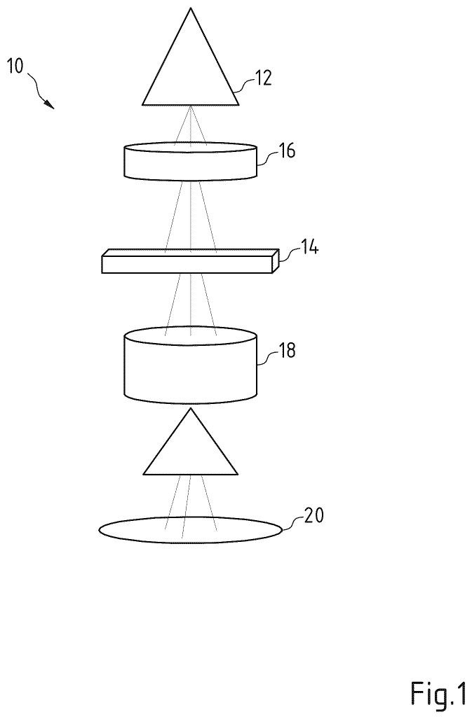

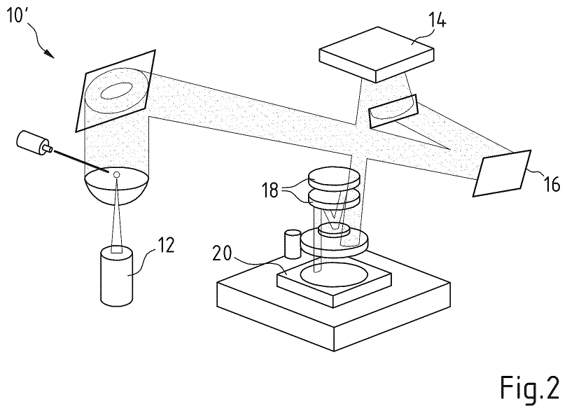

The methods described herein can be used, for example, with transmission-based photolithography systems 10 or reflection-based photolithography systems 10′ as shown in FIGS. 1 and 2.

FIG. 1 illustrates an exemplary transmission-based photolithography system 10, e.g., a DUV photolithography system. Major components are a light source 12, which may be a deep-ultraviolet (DUV) excimer laser source, imaging optics which, for example, may include optics that shape radiation from the light source 12, a photolithography mask 14, illumination optics 16 that illuminate the photolithography mask 14 and projection optics 18 that project an image of the photolithography mask pattern onto a photoresist layer of a wafer 20. An adjustable filter or aperture at the pupil plane of the projection optics 18 may restrict the range of beam angles that impinge on the wafer 20.

In the present document, the terms “radiation” or “beam” are used to encompass all types of electromagnetic radiation, including ultraviolet radiation (e.g., with a wavelength of 365, 248, 193, 157 or 126 nm) and EUV (extreme ultra-violet radiation, e.g. having a wavelength in the range of about 3-100 nm).

Illumination optics 16 may include optical components for shaping, adjusting and/or projecting radiation from the light source 12 before the radiation passes the photolithography mask 14. Projection optics 18 may include optical components for shaping, adjusting and/or projecting the radiation after the radiation passes the photolithography mask 14. The illumination optics 16 exclude the light source 12, the projection optics exclude the photolithography mask 14.

Illumination optics 16 and projection optics 18 may comprise various types of optical systems, including refractive optics, reflective optics, apertures and catadioptric optics, for example. Illumination optics 16 and projection optics 18 may also include components operating according to any of these design types for directing, shaping or controlling the projection beam of radiation, collectively or singularly.

FIG. 2 illustrates an exemplary reflection-based photolithography system 10′, e.g., an extreme ultraviolet light (EUV) photolithography system 10′. Major components are a light source 12, which may be a laser plasma light source, illumination optics 16 which, for example, may include optics that shape radiation from the light source 12, a photolithography mask 14, and projection optics 18 that project an image of the photolithography mask pattern onto a photoresist layer of a wafer 20. An adjustable filter or aperture at the pupil plane of the projection optics 18 may restrict the range of beam angles that impinge on the wafer 20.

The production of objects comprising integrated circuit patterns such as photolithography masks, reticles and wafers requires great care due to the small structure sizes of the integrated circuit patterns. Defects cannot be prevented but can lead to the malfunctioning of semiconductor devices. Therefore, an accurate and fast method for defect detection in objects comprising integrated circuit patterns is important.

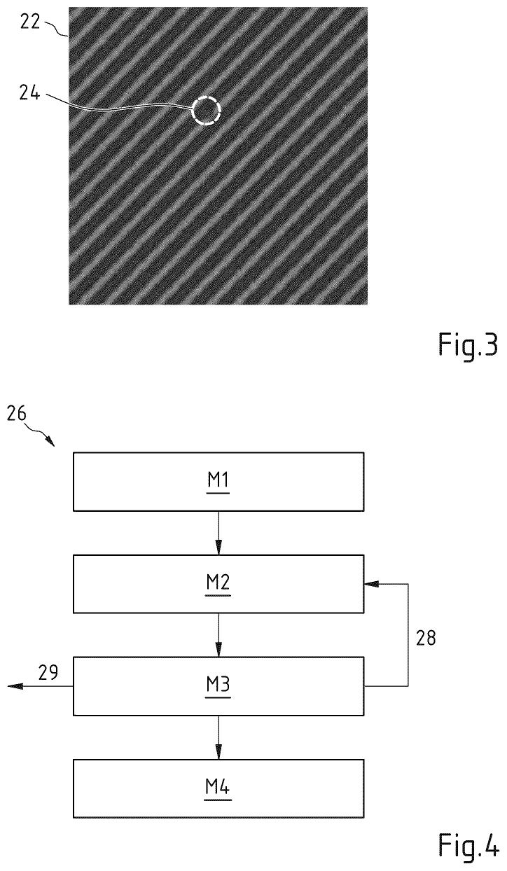

FIG. 3 shows an imaging dataset 22 of an object comprising integrated circuit patterns in the form of a photolithography mask 14 comprising a defect 24. Methods known from the art often use die-to-die or die-to-database methods to detect such defects 24. The imaging dataset 22, in this case, contains a single image of a portion of the object. An imaging dataset 22 can generally refer to one or more images of one or more portions of the object. Die-to-die methods compare a portion of the imaging dataset 22 to another portion of the same or a different imaging dataset 22 to detect defects 24. However, the applicability of die-to-die methods is limited, e.g., repeater defects cannot be discovered and suitable portions for comparison have to be found. In addition, they require the availability and time-consuming scanning of two corresponding portions of the object and exact knowledge about their relative position. Die-to-database methods allow for the detection of any defect 24 by providing a reference dataset that can be directly compared to an imaging dataset 22 of the object comprising integrated circuit patterns. However, the reference dataset must be generated or acquired, and the imaging dataset 22 and the reference dataset must be aligned before the comparison. Both is time-consuming and can lead to alignment errors, which in turn lead to many false positive defect detections. All of these methods have advantages and shortcomings. In addition, images usually contain a lot of redundant information, which makes it difficult to extract the relevant information for defect detection. Therefore, it is a feature of the invention to provide defect detection methods for objects comprising integrated circuit patterns with reduced computation time and improved accuracy and specificity by combining different defect detection methods and explicitly exploiting their strengths.

FIG. 4 illustrates a flowchart of a computer implemented method 26 for defect detection in an imaging dataset of an object comprising integrated circuit patterns according to an embodiment of the invention. The method comprises: obtaining defect candidates in the imaging dataset in a step M1; subsequently carrying out at least two stages in an iteration 28, each stage comprising the following steps: a) applying a stage specific defect detection method to the defect candidates in a step M2; and b) discarding 29 all defect-free defect candidates 34, i.e. defect candidates 30 that are not detected as defect by the stage specific defect detection method, in a step M3. Finally, the detected defects in the imaging dataset are obtained from the remaining defect candidates after the final stage in a step M4.

A defect candidate refers to a subset of the imaging dataset that may comprise a defect and requires further review. A defect candidate is identified by applying a defect detection method to the imaging dataset. By applying a defect detection cascade of stage specific defect detection methods to the defect candidates, defect candidates that may contain a defect can be analyzed with different stage specific defect detection methods in order to take a qualified decision and improve the accuracy of the method. At the same time, defect-free defect candidates can be found quickly, mainly in early stages, and do not have to be examined further. This approach is particularly useful to speed up computations, if relatively few defects are contained in the imaging dataset, for example, in the case that less than 10% of the imaging dataset, preferably less than 5% of the imaging dataset, more preferably less than 3% of the imaging dataset, most preferably less than 1% of the imaging dataset comprises a defect. In addition, intermediate results obtained by a stage specific defect detection method can be re-used by a stage specific defect detection method in a subsequent stage.

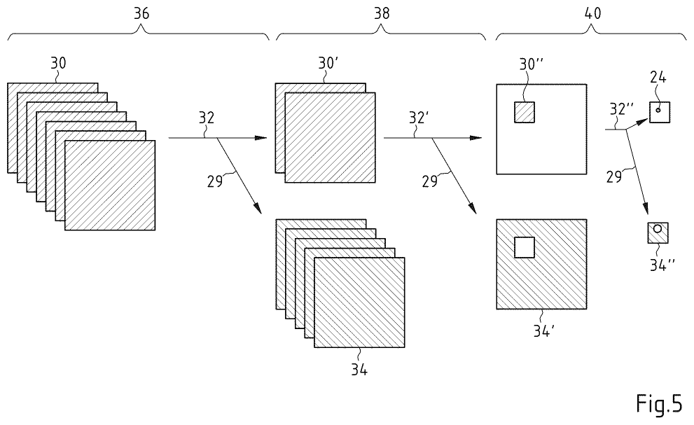

FIG. 5 illustrates the process of iteratively discarding defect candidates in a defect detection cascade. A defect candidate refers to an image or a subsection of an image that may contain a defect. A stage specific defect detection method can comprise partitioning one or more defect candidates into two or more smaller defect candidates. The specific properties of defect candidates depend on the stage specific defect detection method. A stage specific defect detection method can, for example, use complete images of the imaging dataset as input. Another stage specific defect detection method can, for example, be patch-based, i.e., the imaging dataset is partitioned into patches and the stage specific defect detection method is applied to each patch. Another stage specific defect detection method can, for example, use bounding boxes as input, and another stage specific defect detection method can use pixels as input, etc. In this way, the defect candidates can become smaller in successive stages. In an example, each stage contains stage specific defect detection methods that use the same kind of defect candidates, e.g., image-based methods, patch-based methods or pixel-based methods. In an example, each successive stage uses defect candidates of lower size.

In FIG. 5, in the beginning, all images of the imaging dataset 22 of the object comprising integrated circuit patterns are defect candidates 30. Alternatively, regions that are not of interest or regions that are known to be defect-free could be excluded from the defect candidates 30 already at the beginning. In a first stage 36, a stage specific defect detection method 32 is applied to the defect candidates 30. For example, a machine learning model is selected from the stage specific defect detection methods, and the defect candidate 30 is presented as input image to the machine learning model. The machine learning model then indicates a defect likelihood for the defect candidate. Depending, e.g., on a threshold, a defect candidate with a defect likelihood below X % is marked as defect-free defect candidate 34. In this way, a number of defect candidates 30, i.e., complete images, can be discarded. Defect-free defect candidates 34, i.e., images that were found to be defect-free by the stage specific defect detection method 32, are discarded 29 from the defect candidates 30. In a second stage 38, a stage specific defect detection method 32′ is applied to the (remaining) defect candidates 30′. For example, a patch-based stage specific defect detection method is selected. In this case, the remaining defect candidates are partitioned into patches that each becomes a defect candidate, and the stage specific defect detection method is applied to each of these patches. Defect-free defect candidates 34′, i.e., patches 34′ that were found to be defect-free by the stage specific defect detection method 32′, are discarded 29 from the (remaining) defect candidates 30′. In a third stage 40, a stage specific defect detection method 32″ is applied to the (remaining) defect candidates 30″. This stage-specific defect detection method comprises partitioning the defect candidates into pixels. Each pixel becomes a defect candidate. Defect-free defect candidates 34″, i.e., pixels that were found to be defect-free by the stage specific defect detection method 32″, are discarded 29 from the (remaining) defect candidates 30″. After the final third stage 40, the pixels corresponding to the remaining defect candidates are marked as defects 24 in the imaging dataset 22.

For a substantial number of stages, the spatial extent of the defect candidates examined by the stage specific defect detection method is smaller than the spatial extent of defect candidates examined by the stage specific defect detection method in a preceding stage. In an example, in a first stage, for example in the first stage 36, the stage specific defect detection method 32 examines images, and in a subsequent second stage, for example in the second stage 38, the stage specific defect detection method 32′ examines regions such as bounding boxes, and in a subsequent third stage, for example in the third stage 40, the stage specific defect detection method 32″ examines subsets of bounding boxes. Thus, the defect candidates in a first stage comprise images, whereas the defect candidates in a subsequent second stage comprise bounding boxes, and the defect candidates in a subsequent third stage comprise subsets of the bounding boxes. In at least a substantial number of stages, e.g., in each stage, different types of defect detection methods can be used to ensure a fast detection of defect-free defect candidates 34, 34′, 34″ and a very high recall at the same time.

For example, in the first stage 36 a very fast method for discarding defect-free images can be used, e.g., a machine learning model that is trained on defect-free images such as a one-class support vector machine (SVM), a multilayer perceptron with a single hidden layer, a codebook or an autoencoder. A one-class SVM learns to discriminate between common and uncommon instances by learning a hypersphere encompassing common instances. A multilayer perceptron with a single hidden layer is a small neural network with a single hidden layer. A codebook is a fixed-size table of embedding vectors learned by a generative model. An autoencoder is a special type of neural network that is trained to map its input to its output by encoding the input efficiently. These methods learn a subspace of defect-free images from training data. Based on a distance of an image to the learned subspace a decision can be taken if the image contains a defect or not, e.g., by using a threshold. Defect-free images are then discarded from the defect candidates.

In the second stage 38, for example, a fast and rough defect localization method can be applied, which analyzes regions in the defect candidate images for defects 24. For example, a rough bounding box detection using, e.g., Center Net or YOLO (you only look once) can be used in this stage. Center Net is a machine learning based object detector based on keypoint triplets, wherein two keypoints represent opposite corners of a bounding box. A bounding box proposal is preserved if an additional keypoint of the same class is found in the center region of the bounding box. YOLO is a very fast machine learning based object detector that uses a fully convolutional neural network for bounding box prediction. The image is subdivided into grid cells, and for each grid cell a specified number of bounding boxes is predicted that can be larger than the grid cell. Bounding boxes are preserved based on their class probabilities and bounding box confidences. By using bounding box based object detectors, areas comprising a defect 24 can be discriminated from defect-free areas. The defect-free areas can be discarded 29 from the defect candidates 30.

In the third stage 40, for example, a defect localization algorithm with high recall and precision can be used to reliably detect defects 24 in the remaining defect candidate regions. Machine learning methods such as a deep encoder—decoder neural network, e.g., a UNet or an autoencoder can be used. The method can require longer computation times, since it is only applied to the few remaining defect candidates in the final stage. The remaining defect candidates in the final stage after applying the method are marked as defects 24.

As most defect candidates are discarded using fast methods, longer computation times can be spent on unclear or difficult defect candidates in subsequent stages. Thus, in an example, for a substantial number of stages, the computation time of the stage specific defect detection method on all defect candidates in that stage is lower than the computation time of the stage specific defect detection method on the defect-free defect candidates of the subsequent stage. For example, the computation time of the stage specific defect detection method 32 on the defect candidates 30 in the first stage 36 should be lower than the computation time of the stage specific defect detection method 32′ on the defect-free defect candidates 34 in the second stage 38. In this way, the computation time is reduced and the accuracy (e.g., recall and precision) of the detected defects is increased at the same time. In an example, the false negative rate of the substantial number of stage specific defect detection methods is below 5%, preferably below 3%, more preferably below 1%, most preferably below 0.5% or even below 0.1%. Thus, the recall of the substantial number of stage specific defect detection methods is above 95%, preferably above 97%, more preferably above 99%, most preferably above 99.5% or even above 99.9%.

On the one hand, the stage specific defect detection methods 32 in the first stages should ensure that only a very low number of defects is missed in these stages, since a missed defect 24 is discarded and cannot be recovered in a subsequent stage. Thus, a low number of false negatives, a high recall, is desired. On the other hand, the precision of the stage specific defect detection methods 32 in the later stages should increase to reduce the number of false positive defect detections. In particular, it is beneficial, if for a substantial number of stages, the precision of the stage specific defect detection method is higher than the precision of the stage specific defect detection method in a preceding stage. In an example, for a substantial number of stages, the recall of the stage specific defect detection method is lower than the recall of the stage specific detection method in a preceding stage, and the precision of the stage specific defect detection method is higher than the precision of the stage specific defect detection method in a preceding stage. In this way, the recall decreases, whereas the precision increases in subsequent stages. Despite the decreasing recall, a high recall level, e.g., above 0.8, preferably above 0.9, should still be preserved.

In a preferred embodiment of the invention, at least two of the stage specific detection methods 32 only differ in their control parameters. Thus, for each of the at least two stages, the same defect detection method 32 is used, however with different stage specific control parameters. Thus, by modifying the stage specific control parameters of the defect detection method, the same type of defect detection method can be used in different stages. In an example, a substantial number of stage specific defect detection methods 32, in particular all stage specific defect detection methods 32, only differ in their control parameters. In this case, a cascade of defect detection methods is used, wherein the same defect detection method is used in a substantial number of the stages, in particular in all stages, but with different control parameters. In this way, an increasing complexity of the stage specific defect detection method 32 in the substantial number of stages can be realized via the stage specific control parameters.

According to an aspect of the invention, a substantial number of stage specific defect detection methods 32 comprises a machine learning method, and, for each of these stages, the complexity of the machine learning model of the machine learning method is higher than the complexity of the machine learning model of the machine learning method of a preceding stage. In an example, a substantial number of stage specific defect detection methods 32 comprises a trained codebook or a trained autoencoder, etc. With increasing stage index, the number of codebook entries or the number of layers of the autoencoder can increase in order to improve the recall and precision of the model. In this way, an increasing complexity of the machine learning model can be modeled to improve the recall and precision of the stage specific defect detection methods. Training of the machine learning model, e.g., of the codebooks or the autoencoders for the different stages, can be carried out using predominantly defect-free training data, that is defect-free imaging datasets of objects comprising integrated circuit patterns, or subsets thereof.

In case a substantial number of stage specific defect detection methods comprise a codebook, the number of codebook entries can increase with the stage index. In an example, depending on the stage i, the codebook on stage i has 2′ codebook entries. Increasing numbers of codebook entries increase the accuracy of the model, since more complex distributions of defect-free defect candidates (or features thereof in case of an embedding) can be approximated. In case codebooks are used as stage specific defect detection methods 32, the following procedure can be carried out for defect detection during inference. In a first step, defect candidates 30 are defined, e.g. images, bounding boxes or pixels of the imaging dataset 22, and features are extracted from the defect candidates 30. Then, for each stage i=1 . . . N, the distance of each defect candidate (or feature) to the trained codebook of stage i is computed, e.g., by computing the distance to the closest codebook entry. Defect candidates 30 with a small distance to the codebook of stage i are discarded. The remaining defect candidates 30 are passed on to the subsequent stage. In the subsequent stage, the codebook has more codebook entries and can model the distribution of defect-free defect candidates more accurately. Again, defect candidates 30 with a small distance to the codebook of this stage i are discarded. The remaining defect candidates 30 are passed on to the subsequent stage with a larger codebook, and so on. The remaining defect candidates 30 in the final stage are then marked as defects 24. With an increasing number of codebook entries only rare structures such as defects cannot be represented by the codebook. Therefore, the recall and precision increases with the stage index.

In case a substantial number of stage specific defect detection methods comprise an autoencoder, the number of layers of the autoencoder can increase with the stage index. In an example, the autoencoder on stage i has i layers. Increasing numbers of layers of an autoencoder allow to model more complex reconstructions of input datasets. Thus, with a higher stage index, the reconstruction of the imaging dataset becomes more accurate, and, thus, the deviation of the imaging dataset from its reconstruction becomes limited to rare structures in the imaging dataset, e.g., defects. Therefore, with an increasing number of stages and layers the recall and precision of the autoencoders increases. In case a substantial number of stage specific defect detection methods comprise an autoencoder, the following procedure can be carried out for defect detection during inference. In a first step, defect candidates 30 are defined, e.g. images or regions of the imaging dataset 22. Then, for each stage i=1 . . . N, a reconstruction of the defect candidates 30 is computed using the trained autoencoder with i layers by applying the autoencoder with i layers to the defect candidate 30, and the distance of the defect candidate to its reconstruction is computed, e.g., using a norm. Defect candidates 30 with a small distance to their reconstruction are discarded as defect-free defect candidates 34 in stage i. The remaining defect candidates 30 are passed on to the subsequent stage. The remaining defect candidates 30 in the final stage are marked as defects 24.

In an example, intermediate results obtained by a stage specific defect detection method 32 are re-used by a stage specific defect detection method 32 in a subsequent stage, for example, location information or features of the defect candidates 30. This information can, for example, be obtained using image processing or machine learning methods, system parameters such as exposure or focus, or input by a user. In case, stage specific defect detection methods of different stages rely on the same features, e.g. edges, filter responses, activations of layers of neural networks, etc., these features do not have to be re-computed but can be copied from a previous stage.

In an embodiment of the invention, one or more stage specific defect detection methods 32 estimate properties of the defect candidates 30, wherein the properties are used to discard defect-free defect candidates 34. Thus, instead of taking a decision “defect/no defect” based on the imaging dataset 22, properties of the defect candidates 30 can be used additionally or instead, for example in a fast filtering stage. The properties can, for example, include size, shape, location, material, appearance, etc. of the defect candidates 30. These can be obtained using, for example, image processing, machine learning or user input. Using a threshold or predefined ranges or lists of property values, defect-free defect candidates 34 can be detected quickly based on their properties. For example, very small defect candidates 30, or defect candidates 30 in a location that is not of interest or defect candidates of a specific material that is not of interest, can be discarded in this way. Thus, a fast filtering stage can be carried out.

In an example, in each stage a different threshold can be used to discard defect-free defect candidates 34. Thus, in earlier stages, thresholds that prevent discarding defects can be used, while in later stages thresholds can be used to discard false positive defect detections.

According to an embodiment of the invention, for at least one stage, preferably for a substantial number of stages, the stage specific defect detection method 32 is selected from a set of stage specific defect detection methods 32. Each set of stage specific defect detection methods 32 can comprise two or multiple stage specific defect detection methods 32, e.g., different methods and/or methods with different stage specific control parameters. In this way, a user can select a stage specific defect detection method 32 that is particularly adapted to the imaging dataset 22 to obtain improved defect detection results.

According to an aspect of the invention, the stage specific defect detection method 32 is automatically selected from the set of stage specific defect detection methods 32 according to some criterion. The criterion can, for example, comprise the computation time, meta-data concerning the imaging dataset, the recall or precision rate, a confidence level in case of machine learning methods (e.g., obtained using softmax), a true positive or a true negative rate on comparable data, or an efficiency of the stage specific defect detection method. For example, the stage specific defect detection method can be selected such that the computation time, the recall, the precision, the confidence level, the true positive rate, the true negative rate or efficiency increases in each stage. To this end, different stage specific defect detection methods can be associated with different levels of computation time, recall, precision, confidence level, true positive rate, true negative rate or efficiency, e.g., “low”, “intermediate”, “high” or a number within a range. Depending on a desired level, a corresponding stage specific defect detection method can be automatically selected. To this end, a database with properties of the stage specific defect detection methods can be provided that contains information on different criteria. Using a query on the database with a criterion or a combination of criteria, suitable stage specific defect detection methods can be proposed and automatically selected. If there are several methods fulfilling the criterion or criteria, one method can be selected randomly. The efficiency can, for example, be defined using the computation time per pixel and the reduction ratio (i.e., the percentage of defect candidates left after applying the stage specific defect detection method). The stage specific defect detection method can be automatically selected at each stage. Alternatively, a sequence of stage-specific defect detection methods can be automatically designed before the first stage. For example, the complete efficiency e of a sequence of n stage-specific defect detection methods 32 can be computed as

$$e = {\sum }_{i = 1}^{n} \frac{D C {\prod }_{j = 0}^{i - 1} {r}_{j}}{{v}_{i}} , \qquad ( 1 )$$

where rⱼ indicates the reduction rate of defect detection method j (the percentage of defect candidates 30 left after application of the defect detection method 32 with r₀=1), vⱼ indicates the computation time per pixel of the defect detection method j and DC indicates the number of defect candidates 30 before the first stage.

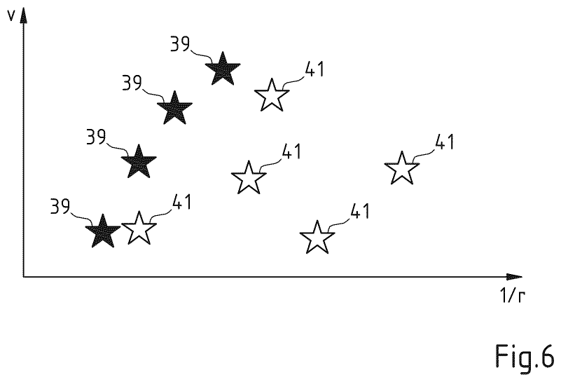

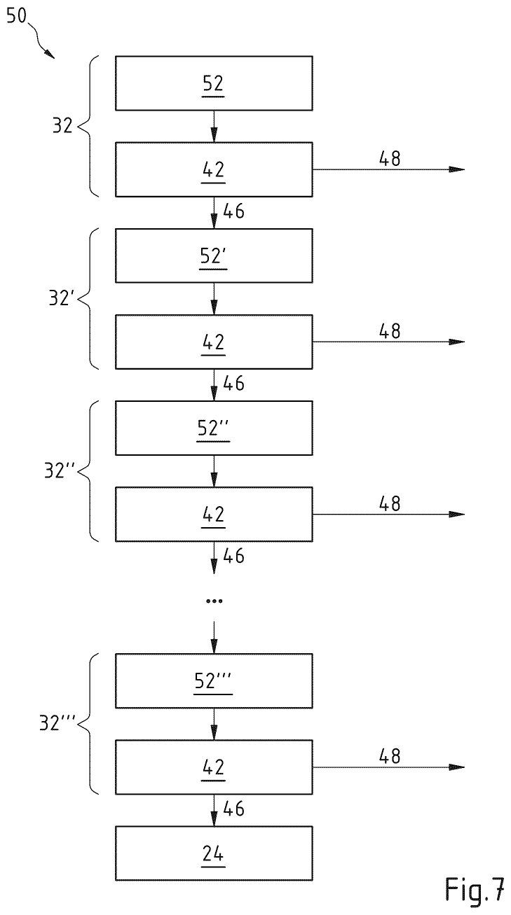

FIG. 6 illustrates efficiencies for different defect detection methods 32. On the horizontal axis the inverse of the reduction rate 1/r is indicated, and on the vertical axis the computation time per pixel. The favorable defect detection methods 39 can be useful due to their combination of computation time and reduction factor, whereas the unfavorable defect detection methods 41 are not useful. Which one of the favorable defect detection methods 39 is best suited can, for example, be decided by optimizing the complete efficiency e in equation (1).

In an example, the stage specific defect detection method 32 is selected from the set of stage specific defect detection methods using meta-data concerning the imaging dataset 22. Each stage specific defect detection method can, for example, be associated with different meta-data. The associations can be saved in a database. Using a query with user-desired meta-data, a stage specific defect detection method fulfilling the desired meta-data can be selected from the database. For example, machine learning methods can be trained using training data that obeys specific meta-data, e.g., is obtained at object boundaries, is of a specific modality, contains only a specific type of pattern, etc. The meta-data can, for example, concern the contents of the imaging dataset, e.g., the type of integrated circuit patterns in the imaging dataset such as memory or logic structures. For example, a stage specific defect detection method 32 for an imaging dataset comprising lines and spaces can be different from a stage specific defect detection method 32 for an imaging dataset comprising dense pillars or S-shape logic structures. The meta-data can, for example, concern the type of structures or integrated circuit patterns in the object, the critical dimension of the structures, the expected minimum size of relevant defects to be detected, the type of defects to be detected, the quality of the imaging dataset (e.g., the noise level, contrast, brightness, etc.), image acquisition settings, the modality of the imaging dataset (e.g., SEM images, FIB-SEM images, CT images, MRT images, Xray images, AFM images, aerial images), the location of the imaged area in the object comprising integrated circuit patterns, the type of imaged area in the object comprising integrated circuit patterns (e.g., border regions or die regions), etc.

In an example, one or more stage specific defect detection methods 32 use a reference dataset to discard defect-free defect candidates 34. Defective defect candidates 30 can, for example, be detected by comparing the imaging dataset 22 or a pre-processed imaging dataset to the reference dataset. A threshold can, for example, be applied to the deviation of the (pre-processed) imaging dataset 22 from the reference dataset, e.g., measured by some kind of norm. Defect-candidates with a deviation below the threshold can be discarded as defect-free defect candidates 34. The reference dataset can comprise an acquired imaging dataset or a simulated imaging dataset. An acquired imaging dataset is, preferably, predominantly defect-free. A simulated imaging dataset can be obtained from a model, e.g., from a CAD file. The appearance of a simulated imaging dataset can be modified to resemble the appearance of an acquired imaging dataset, e.g., using a generative adversarial neural network (GAN).

According to an embodiment of the invention illustrated in FIG. 7, the computer implemented method for defect detection comprises a machine learning model 50, wherein the stage specific defect detection method 32, 32′, 32″, 32′″ in a substantial number of stages comprises at least one intermediate layer 52, 52′, 52″, 52′″ followed by a classifier 42 that classifies intermediate results as defect 46 or non-defect 48 in the machine learning model 50. As classifier a machine learning model for classification can be used, e.g., a SVM, a neural network, etc. The classifier is trained using training data specific for the intermediate layer 52, 52′, 52″, 52′″ it follows containing the output of the intermediate layer and a defect/no defect indicator. Thus, the machine learning model 50 comprises multiple intermediate layers 52, 52′, 52″, 52′″, interleaved with classifiers 42. In this way, additional computations in further stages for clearly defect-free defect-candidates 34 are prevented.

A computer-readable medium according to an embodiment of the invention, has a computer program executable by a computing device stored thereon, the computer program comprising code for executing a method according to any of the embodiments, examples or aspects described above.

A computer program product according to an embodiment of the invention comprises instructions which, when the program is executed by a computer, cause the computer to carry out a method of any of the embodiments, examples or aspects described above.

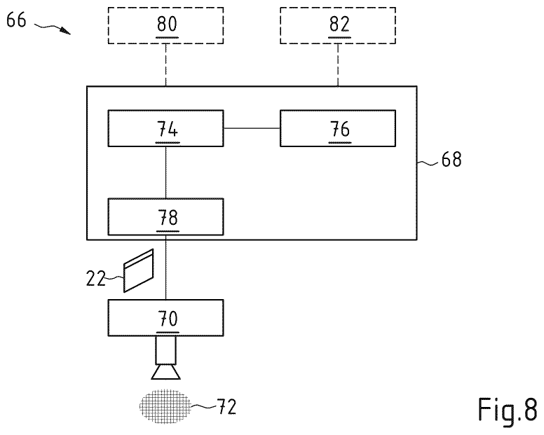

A system 66 for defect detection in an object 72 comprising integrated circuit patterns according to an embodiment of the invention illustrated in FIG. 8 comprises an imaging device 70 for obtaining an imaging dataset 22 of the object 72 comprising integrated circuit patterns and a data analysis device 68 comprising one or more processing devices 74 and one or more machine-readable hardware storage devices 76 comprising instructions that are executable by one or more processing devices 74 to perform operations comprising a computer implemented method 26 for defect detection in an object 72 comprising integrated circuit patterns as described above.

The system 66 optionally comprises a database 80 for loading and/or saving data, e.g., machine learning models, defect detection method control parameters, reference datasets, stage sequences comprising the stage specific defect detection methods and their parameters for different or all stages, training data, defect properties, properties of stage specific defect detection methods such as recall, precision, computation time, etc. The imaging device 70 for obtaining an imaging dataset 22 of the object 72 comprising integrated circuit patterns can comprise a charged particle beam device, for example, a Helium ion microscope, a cross-beam device including FIB and SEM, an atomic force microscope or any charged particle imaging device, or an aerial image acquisition system. The imaging device 70 for obtaining an imaging dataset 22 of the object 72 comprising integrated circuit patterns can provide an imaging dataset 22 to the data analysis device 68. The data analysis device 68 includes one or more processors 74, e.g., implemented as a central processing unit (CPU) or graphics processing unit (GPU). The one or more processor 74 can receive the imaging dataset 22 via an interface 78. The one or more processor 74 can load program code from a hardware-storage device 76, e.g., program code for executing a computer implemented method 26 for detecting defects 24 according to an embodiment of the invention as described above, or for training a machine learning model, etc. The one or more processor 74 can execute the program code. The system 66 optionally comprises a user interface 82, e.g., for monitoring the training progress of a machine learning model, for selecting training parameters, for selecting a stage specific defect detection method 32, etc.

The methods disclosed herein can, for example, be used during research and development of objects comprising integrated circuit patterns or during high volume manufacturing of objects comprising integrated circuit patterns, or for process window qualification or enhancement. In addition, the methods disclosed herein can also be used for defect detection of X-ray imaging datasets of objects comprising integrated circuit patterns, e.g., after packaging the semiconductor device for delivery.

In some implementations, after the defects are found using the methods and systems described above, the photolithography mask can be modified to repair or eliminate the defects. Repairing the defects can include, e.g., depositing materials on the mask using a deposition process, or removing materials from the mask using an etching process. Some defects can be repaired based on exposure with focused electron beams and adsorption of precursor molecules.

In some implementations, a repair device for repairing the defects on a mask can be configured to perform an electron beam-induced etching and/or deposition on the mask. The repair device can include, e.g. an electron source, which emits an electron beam that can be used to perform electron beam-induced etching or deposition on the mask. The repair device can include mechanisms for deflecting, focusing and/or adapting the electron beam. The repair device can be configured such that the electron beam is able to be incident on a defined point of incidence on the mask.

The repair device can include one or more containers for providing one or more deposition gases, which can be guided to the mask via one or more appropriate gas lines. The repair device can also include one or more containers for providing one or more etching gases, which can be provided on the mask via one or more appropriate gas lines. Further, the repair device can include one or more containers for providing one or more additive gases that can be supplied to the one or more deposition gases and/or the one or more etching gases.

The repair device can include a user interface to allow an operator to, e.g., operate the repair device and/or read out data.

The repair device can include a computer unit configured to cause the repair device to perform one or more of the methods described herein, based at least in part on an execution of an appropriate computer program.

In some implementations, the information about the defects serve as feedback to improve the process parameters of the manufacturing process, e.g., exposure time, focus, illumination, etc. For example, after the defects are identified from a first photolithography mask or first batch of photolithography masks, the process parameters of the manufacturing process are adjusted to reduce defects in a second mask or a second batch of masks.

In some implementations, the processing of data described above can be carried out by one or more computers that include one or more data processors configured to execute one or more programs that include a plurality of instructions according to the principles described above. Each data processor can include one or more processor cores, and each processor core can include logic circuitry for processing data. For example, a data processor can include an arithmetic and logic unit (ALU), a control unit, and various registers. Each data processor can include cache memory. Each data processor can include a system-on-chip (SoC) that includes multiple processor cores, random access memory, graphics processing units, one or more controllers, and one or more communication modules. Each data processor can include millions or billions of transistors.

The methods described in this document can be carried out using one or more computing devices, which can include one or more data processors for processing data, one or more storage devices for storing data, and/or one or more computer programs including instructions that when executed by the one or more computing devices cause the one or more computing devices to carry out the method steps or processing steps. The one or more computing devices can include one or more input devices, such as a keyboard, a mouse, a touchpad, and/or a voice command input module, and one or more output devices, such as a display, and/or an audio speaker.

In some implementations, the one or more computing devices can include digital electronic circuitry, computer hardware, firmware, software, or any combination of the above. The features related to processing of data can be implemented in a computer program product tangibly embodied in an information carrier, e.g., in a machine-readable storage device, for execution by a programmable processor; and method steps can be performed by a programmable processor executing a program of instructions to perform functions of the described implementations. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a programmable processor.

A computer program can be written in any form of programming language, including compiled or interpreted languages, and it can be deployed in any form, including as a stand-alone program or as a module, component, subroutine, or other unit suitable for use in a computing environment.

For example, the one or more computers can be configured to be suitable for the execution of a computer program and can include, by way of example, both general and special purpose microprocessors, and any one or more processors of any kind of digital computer. Generally, a processor will receive instructions and data from a read-only storage area or a random access storage area or both. Elements of a computer system include one or more processors for executing instructions and one or more storage area devices for storing instructions and data. Generally, a computer system will also include, or be operatively coupled to receive data from, or transfer data to, or both, one or more machine-readable storage media, such as hard drives, magnetic disks, solid state drives, magneto-optical disks, or optical disks. Machine-readable storage media suitable for embodying computer program instructions and data include various forms of non-volatile storage area, including by way of example, semiconductor storage devices, e.g., EPROM, EEPROM, flash storage devices, and solid state drives; magnetic disks, e.g., internal hard disks or removable disks; magneto-optical disks; and CD-ROM, DVD-ROM, and/or Blu-ray discs.

In some implementations, the processes described above can be implemented using software for execution on one or more mobile computing devices, one or more local computing devices, and/or one or more remote computing devices (which can be, e.g., cloud computing devices). For instance, the software forms procedures in one or more computer programs that execute on one or more programmed or programmable computer systems, either in the mobile computing devices, local computing devices, or remote computing systems (which may be of various architectures such as distributed, client/server, grid, or cloud), each including at least one processor, at least one data storage system (including volatile and non-volatile memory and/or storage elements), at least one wired or wireless input device or port, and at least one wired or wireless output device or port.

In some implementations, the software may be provided on a medium, such as CD-ROM, DVD-ROM, Blu-ray disc, a solid state drive, or a hard drive, readable by a general or special purpose programmable computer or delivered (encoded in a propagated signal) over a network to the computer where it is executed. The functions can be performed on a special purpose computer, or using special-purpose hardware, such as coprocessors. The software can be implemented in a distributed manner in which different parts of the computation specified by the software are performed by different computers. Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system can also be considered to be implemented as a computer-readable storage medium, configured with a computer program, where the storage medium so configured causes a computer system to operate in a specific and predefined manner to perform the functions described herein.

Reference throughout this specification to “an embodiment” or “an example” or “an aspect” means that a particular feature, structure or characteristic described in connection with the embodiment, example or aspect is included in at least one embodiment, example or aspect. Thus, appearances of the phrases “according to an embodiment,” “according to an example” or “according to an aspect” in various places throughout this specification are not necessarily all referring to the same embodiment, example or aspect, but may refer to different embodiments. Furthermore, the particular features or characteristics may be combined in any suitable manner, as would be apparent to one of ordinary skill in the art from this disclosure, in one or more embodiments.

In this document, the phrase “a machine learning method comprising a trained machine learning model” means a machine learning method includes applying a trained machine learning model to perform a task, e.g., applying the training machine learning model to each of the defect candidates to determine whether the defect candidate has a defect or is defect-free. The phrase “stage specific defect detection method” is interchangeable with the phrase “stage specific defect detection process,” and may include one or more method or process steps. The phrase “intermediate results obtained by a stage specific defect detection method are re-used by a stage specific defect detection method in a subsequent stage” means that, for stage n that has a subsequent n+1 stage, n being a positive integer number, intermediate results obtained by a stage specific defect detection method in a stage n are re-used by a stage specific defect detection method in a subsequent stage n+1. The intermediate results obtained by the stage specific defect detection method in the last stage are not re-used.

Furthermore, while some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

The invention can be described by the following clauses:
1. A computer implemented method 26 for defect detection in an imaging dataset 22 of an object 72 comprising integrated circuit patterns, the method 26 comprising:
   Obtaining defect candidates 30 in the imaging dataset 22;
   Subsequently carrying out at least two stages 36, 38, 40, each stage 36, 38, 40 comprising the following steps:
      Applying a stage specific defect detection method 32 to the defect candidates 30;
      Discarding all defect-free defect candidates 34; and
   Obtaining the detected defects 24 in the imaging dataset 22 from the remaining defect candidates 30.
2. The method of clause 1, wherein at least three stages 36, 38, 40 are carried out.
3. The method of clause 1, wherein three stages 36, 38, 40 are carried out.
4. The method of any one of the preceding clauses, wherein, for a substantial number of stages 36, 38, 40, the spatial extent of the defect candidates 30 examined by the stage specific defect detection method 32 is smaller than the spatial extent of defect candidates 30 examined by the stage specific defect detection method 32 in a preceding stage.
5. The method of clause 4, wherein the defect candidates 30 comprise images in a first stage 36, bounding boxes within the images in a subsequent second stage 38 and subsets of the bounding boxes in a subsequent third stage 40.
6. The method of any one of the preceding clauses, wherein, for a substantial number of stages 36, 38, 40, the computation time of the stage specific defect detection method 32 on all defect candidates 30 in that stage is lower than the computation time of the stage specific defect detection method 32 on the defect-free defect candidates 34 of the subsequent stage.
7. The method of any one of the preceding clauses, wherein the false negative rate of the stage specific detection method 32 is below 5%, preferably below 2%, more preferably below 1%, most preferably below 0.5% or even below 0.1%.
8. The method of any one of the preceding clauses, wherein, for a substantial number of stages 36, 38, 40, the precision of the stage specific defect detection method 32 is higher than the precision of the stage specific defect detection method 32 in a preceding stage.
9. The method of any one of the preceding clauses, wherein at least two of the stage specific defect detection methods 32 only differ in their control parameters.
10. The method of any one of the preceding clauses, wherein less than 10% of the imaging dataset 22, preferably less than 5% of the imaging dataset 22, more preferably less than 3% of the imaging dataset 22, most preferably less than 1% of the imaging dataset 22 comprise a defect 24.
11. The method of any one of the preceding clauses, wherein intermediate results obtained by a stage specific defect detection method 32 are re-used by a stage specific defect detection method 32 in a subsequent stage.
12. The method of any one of the preceding clauses, wherein one or more stage specific defect detection methods 32 estimate properties of the defect candidates 30, and wherein the properties are used to discard defect-free defect candidates 34.
13. The method of any one of the preceding clauses, wherein at least one stage specific defect detection method 32 comprises a machine learning method, the machine learning method comprising a trained machine learning model.
14. The method of clause 13, wherein a substantial number of stage specific defect detection methods 32 comprise a machine learning method, and wherein, for these stages 36, 38, 40 the complexity of the machine learning model of the machine learning method is higher than the complexity of the machine learning model of the machine learning method of a preceding stage.
15. The method of any one of the preceding clauses, wherein, for at least one stage 36, 38, 40, the stage specific defect detection method 32 is selected from a set of stage specific defect detection methods 32.
16. The method of clause 15, wherein, for at least one stage 36, 38, 40, the stage specific defect detection method 32 is automatically selected from the set of stage specific defect detection methods 32 according to some criterion.
17. The method of clause 15 or 16, wherein, for at least one stage 36, 38, 40, the stage specific defect detection method 32 is selected from the set of stage specific defect detection methods 32 using meta-data concerning the imaging dataset 22.
18. The method of any one of the preceding clauses, wherein one or more stage specific defect detection methods 32 use a reference dataset to discard defect-free defect candidates 34.
19. The method of any one of clauses 1 to 16, wherein the computer implemented method for defect detection comprises a machine learning model 50, and wherein the stage specific defect detection method 32 in a substantial number of stages 36, 38, 40 comprises at least one intermediate layer 52 followed by a classifier 42 that classifies intermediate results as defect 24 or non-defect in the machine learning model 50.
20. A computer-readable medium, on which a computer program executable by a computing device is stored, the computer program comprising code for executing a method of any one of the preceding clauses.
21. A computer program product comprising instructions which, when the program is executed by a computer, cause the computer to carry out a method of any one of the preceding method clauses.
22. A system 66 for defect detection in an object 72 comprising integrated circuit patterns, the system 66 comprising:
   an imaging device 70 configured to provide an imaging dataset 22 of the object 72 comprising integrated circuit patterns;
   one or more processing devices 74;
   one or more machine-readable hardware storage devices 76 comprising instructions that are executable by one or more processing devices to perform operations comprising any one of the methods of the preceding method clauses.
23. A method comprising:
   detecting at least one defect in an object using the method for defect detection of any one of clauses 1 to 19;
   modifying the object to at least one of reduce, repair, or remove the at least one defect.
24. The method of clause 23 wherein the object comprises at least one of a photolithographic mask, a reticle, or a wafer.
25. The method of clause 23 or 24 wherein modifying the object comprises at least one of (i) depositing one or more materials onto the object, (ii) removing one or more materials from the object, or (iii) locally modifying a property of the object.
26. The method of clause 25 wherein locally modifying a property of the object comprises writing one or more pixels on the object to locally modify at least one of a density, a refractive index, a transparency, or a reflectivity of the object.
27. A method comprising:
   processing a first object using a manufacturing process that comprises at least one process parameter;
   detecting at least one defect in the first object using the method for defect detection of any one of clauses 1 to 19; and
   modifying the manufacturing process based on information about the at least one defect in the first object that has been detected to reduce the number of defects or eliminate defects in a second object to be produced by the manufacturing process.
28. The method of clause 27 wherein the object comprises at least one of a photolithographic mask, a reticle, or a wafer.
29. The method of clause 27 or 28 wherein modifying the manufacturing process comprises modifying at least one of an exposure time or a focus variation of the manufacturing process.

30. A method comprising:
processing a plurality of regions on a first object using a manufacturing process that comprises at least one process parameter, wherein different regions are processed using different process parameter values;
applying the method for defect detection of any one of clauses 1 to 19 to each of the regions to obtain information about zero or more defects in the region;
identifying, using a quality criterion or criteria, a first region among the regions based on information about the zero or more defects;
identifying a first set of process parameter values that was used to process the first region; and
applying the manufacturing process with the first set of process parameter values to process a second object.
31. The method of clause 30 wherein the object comprises a photolithographic mask, a reticle, or a wafer, and the regions comprise dies on the mask, reticle, or wafer.
32. The method of clause 30 or 31 wherein the information about the zero or more defects comprises the number and/or characteristics of the zero or more defects.
33. The method of any one of the preceding clauses, wherein one or more stage specific defect detection methods comprise partitioning one or more defect candidates into two or more smaller defect candidates.

In summary, the invention relates to a computer implemented method 26 for defect detection in an imaging dataset 22 of an object 72 comprising integrated circuit patterns, the method 26 comprising: obtaining defect candidates 30 in the imaging dataset 22; subsequently carrying out at least two stages 36, 38, 40, each stage 36, 38, 40 comprising the following steps: applying a stage specific defect detection method 32 to the defect candidates 30; discarding all defect-free defect candidates 34; obtaining detected defects 24 in the imaging dataset 22 from the remaining defect candidates 30.

### REFERENCE NUMBER LIST

10, 10′ Photolithography system
12 Light source
14 Photolithography mask
16 Illumination optics
18 Projection optics
20 Wafer
22 Imaging dataset
24 Defect
26 Computer implemented method
28 Iteration
29 Discarding
30, 30′, 30″ Defect candidates
32, 32′, 32″, 32′″ Stage specific defect detection method
34, 34′, 34″ Defect-free defect candidates
36 First stage
38 Second stage
39 Favorable stage specific defect detection method
40 Third stage
41 Unfavorable stage specific defect detection method
42 Classifier
44 n-th stage
46 No defect
48 Defect
50 Machine learning model
52, 52′, 52″, 52′″ Intermediate layers
66 System
68 Data analysis device
70 Imaging device
72 Object
74 Processing device
76 Hardware-storage device
78 Interface
80 Database
82 User interface

What is claimed is:

1. A computer implemented method for defect detection in an imaging dataset of an object comprising integrated circuit patterns, the method comprising:
obtaining defect candidates in the imaging dataset;
subsequently carrying out at least two stages, each stage comprising the following steps:
applying a stage specific defect detection method to the defect candidates;
discarding defect-free defect candidates; and
obtaining detected defects in the imaging dataset from the remaining defect candidates.

2. The method of claim 1, wherein at least three stages are carried out.

3. The method of claim 1, wherein three stages are carried out.

4. The method of claim 1, wherein, for at least 50% of stages, the spatial extent of the defect candidates examined by the stage specific defect detection method is smaller than the spatial extent of defect candidates examined by the stage specific defect detection method in a preceding stage.

5. The method of claim 4, wherein the defect candidates comprise images in a first stage, bounding boxes within the images in a subsequent second stage and subsets of the bounding boxes in a subsequent third stage.

6. The method of claim 1, wherein, for at least 50% of stages, the computation time of the stage specific defect detection method on all defect candidates in that stage is lower than the computation time of the stage specific defect detection method on the defect-free defect candidates of the subsequent stage.

7. The method of claim 1, wherein the false negative rate of the stage specific detection methods is below 5%.

8. The method of claim 1, wherein, for at least 50% of stages, the precision of the stage specific defect detection method is higher than the precision of the stage specific defect detection method in a preceding stage.

9. The method of claim 1, wherein at least two of the stage specific defect detection methods only differ in their control parameters.

10. The method of claim 1, wherein less than 10% of the imaging dataset comprise a defect.

11. The method of claim 1, wherein intermediate results obtained by a stage specific defect detection method are re-used by a stage specific defect detection method in a subsequent stage.

12. The method of claim 1, wherein one or more stage specific defect detection methods estimate properties of the defect candidates, and wherein the properties are used to discard defect-free defect candidates.

13. The method of claim 1, wherein at least one stage specific defect detection method comprises a machine learning method, the machine learning method comprising a trained machine learning model.

14. The method of claim 13, wherein at least 50% of stage specific defect detection methods comprise a machine learning method, and wherein, for these stages the complexity of the machine learning model of the machine learning method is higher than the complexity of the machine learning model of the machine learning method of a preceding stage.

15. The method of any claim 1, wherein, for at least one stage, the stage specific defect detection method is selected from a set of stage specific defect detection methods.

16. The method of claim 15, wherein, for at least one stage, the stage specific defect detection method is automatically selected from the set of stage specific defect detection methods according to a predetermined criterion.

17. The method of claim 16, wherein, for at least one stage, the stage specific defect detection method is selected from the set of stage specific defect detection methods using meta-data concerning the imaging dataset.

18. The method of claim 1, wherein one or more stage specific defect detection methods use a reference dataset to discard defect-free defect candidates.

19. The method of claim 1, wherein the computer implemented method for defect detection comprises a machine learning model, and wherein the stage specific defect detection method in at least 50% of stages comprises at least one intermediate layer followed by a classifier that classifies intermediate results as defect or non-defect in the machine learning model.

20. A computer-readable medium, on which a computer program executable by a computing device is stored, the computer program comprising code for executing a method of claim 1.

21. A computer program product comprising instructions which, when the program is executed by a computer, cause the computer to carry out a method of claim 1.

22. A system for defect detection in an object comprising integrated circuit patterns, the system comprising:
an imaging device configured to provide an imaging dataset of the object comprising integrated circuit patterns;
one or more processing devices;
one or more machine-readable hardware storage devices comprising instructions that are executable by one or more processing devices to perform operations comprising the method of claim 1.
